(19) United States
(12) Patent Application Publication
(10) Pub. No.: US 2015/0211660 A1
(43) Pub. Date: Jul. 30, 2015

(54) HOSE HOLDER

(71) Applicant: WESTERN POWER SPORTS, INC., BOISE, ID (US)

(72) Inventors: MATTHEW RICE, BOISE, ID (US); RANDY LAWRENCE, Boise, ID (US)

(21) Appl. No.: 14/607,953

(22) Filed: Jan. 28, 2015

Related U.S. Application Data
(60) Provisional application No. 61/932,638, filed on Jan. 28, 2014.

(51) Int. Cl. F16L 3/26; F16L 3/137

(52) U.S. Cl. CPC F16L 3/26; F16L 3/137

(57) ABSTRACT

A tube holder for holding a tube in a selected position. The tube holder has a first band that grips a tube at one end, and a second band that grips a tube at a second end. The bands are spaced apart and held in a selected angle to each other, to hold the tube at a selected angle. Each band has a gap that allows the tube to be inserted into the band without having to thread the tube in from an end of the device.

### PRIORITY/CROSS-REFERENCE TO RELATED APPLICATIONS

This application claims the benefit of U.S. Provisional Application No. 61/932,638, filed Jan. 28, 2014 the disclosure of which is incorporated by reference.

### TECHNICAL FIELD

The presently disclosed technology relates to tubing positioners, and specifically to tubing positioners or holders.

### BACKGROUND

There are many uses of flexible tubing or hose in various kinds of machinery or devices. As an example, a water hose or a hose that comes out of a gas can may be a flexible hose. Small diameter flexible hoses can be found in engines as gas lines or vacuum lines, and hoses may be present to carry liquids or gases in various devices. Many times it is desirable to have a bend at a certain angle in the flexible hose. If the bend can be accomplished without putting a connection in the hose such as an angle connector or an elbow, that is preferable because a connector or elbow increases turbulence of the fluid and introduces resistance to the flow of the fluid. A smooth bending tube with no internal obstructions is preferable to various connectors which change the direction of the tube. Also, it can be desirable for a device which changes the angle of the tubing to be able to snap on and off the tubing without having to cut into the tubing.

### SUMMARY OF THE DISCLOSURE

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

The intention of this device is to bend a hose and keep it bent. The device bends the hose at a certain angle (currently designed at 60 degrees). The device was specifically designed to be installed at any point of the hose—meaning that the hose does not have to be disconnected or modified to have the device installed. The installation and removal of the device is done by hand. The installer inserts the hose into a channel, then bend using the device, and finishes by installing the hose into the opposite channel. The removal of the device is the same as the installation process.

The disclosed device is a tubing holder for tubing at a selected angle, from 0° to approximately 90°. The device is for holding flexible tubing at an angle, in which the tubing is generally straight, and the tubing holder forces it and holds it into a curved position. One use of such a tubing holder would be to bend the tubing that comes out of a water carrying container or a gas carrying container, to make the liquids easier to pour when the spout is at an angle. Other uses are numerous, wherever flexible cable is used which can benefit from having the tubing held at a curved angle.

The disclosed device includes a device body which is in a curved shape, at an angle selected by the user. The device body has a side that is inside the curve and a side that is outside the curve. It also has a left side and a right side. At one end of the device body is a first band which partially encircles the round cross section tubing that is being held. The first band has a first gap on either the left or the right side which allows the device body to be snapped onto a length of tubing without having to thread the tubing from one end to the other. If the first gap were on the outside side of the curve, it wouldn't hold the tubing and it would just snap out.

The device body also has a second band at the other end from the first band, which also has a second gap which is on either the right or the left side, which also allows the device to be snapped onto a piece of tubing and to impart the bend of the device body into the tubing. The two bands are held in a spaced apart relationship to each other by a connector piece, which is curved not only to match the curve between the first and the second band, but also is curved to match the curved sidewall of the tubing. The surface curvature of the tubing has a certain curve which is called the radial surface curvature of the tubing, and the connector piece is thus shaped to conform to that curve.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a perspective view of the disclosed tube holder.

FIG. 2 is a perspective view of the disclosed tube holder, with a length of tubing being secured at an angle.

FIG. 3 is a side view of the left side of the disclosed tube holder.

FIG. 4 is a side view of the inside curve of the disclosed tube holder.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

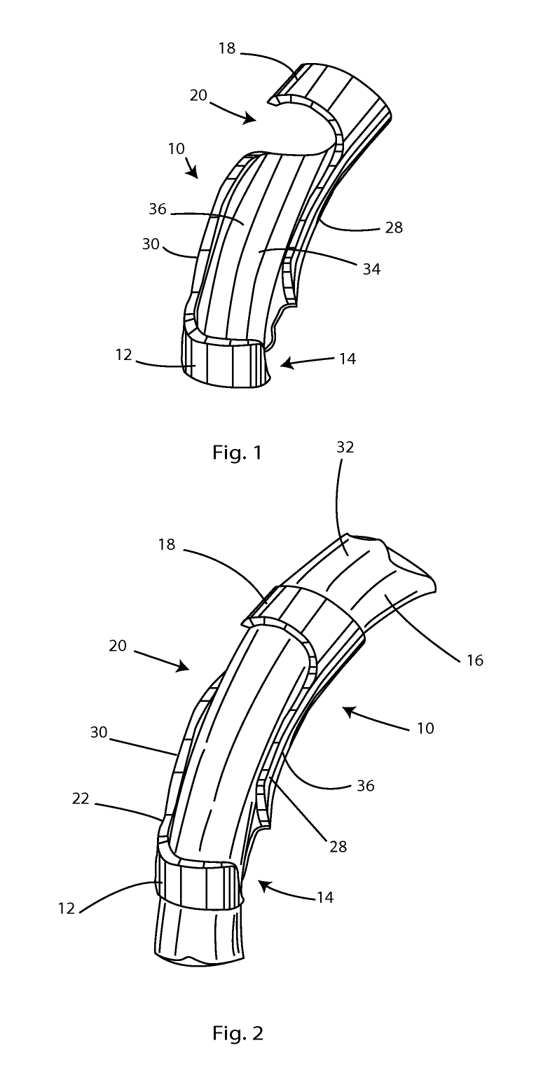

Shown in the FIGS. 1 through 4 is the tube holder of the disclosed technology. FIG. 1 shows the tube holder with a first band 12, a second band 18, a first gap 14, a second gap 20, and a connector piece 36.

FIG. 1 shows the left side 28 of the device, and the right side 30. FIG. 1 shows the curve of the connector piece 34,

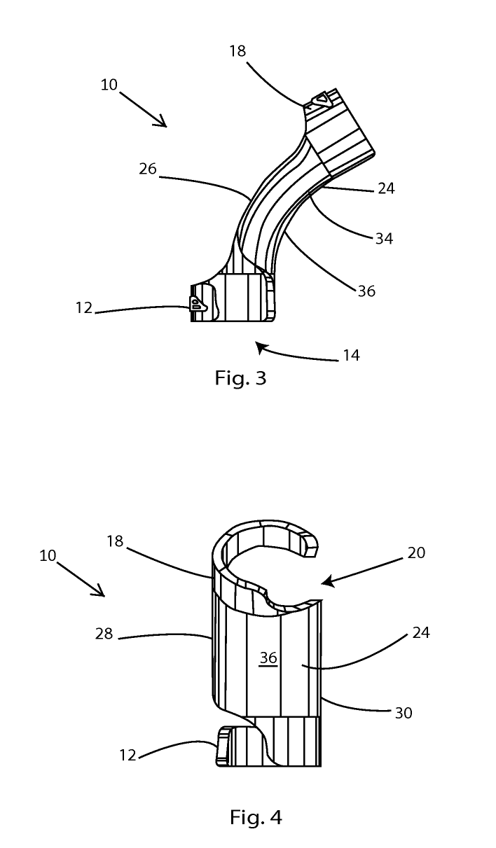

FIG. 2 shows the same view of the device 10, with a length of tubing 16 being secured in the tubing holder 10. The device body is shown at 22. FIG. 3 is a side view of the device 10, and shows the left side 28 of the device, as well as the side on the outside of the curve 26, and the side inside the curve 24.

FIG. 4 shows the side inside the curve 24 and FIG. 3 shows the side outside the curve 26.

The disclosed device is preferably made of plastic, but various metals would also work for the material of the device.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

We claim:

1. A tubing holder for holding tubing at a selected angle, comprising:
a first band configured to partially encircle a generally round cross section tubing, said first band with a first gap for passage of a length of tubing to be held by said tubing holder;
a second band configured to partially encircle a generally round cross section tubing, said second band with a second first gap for passage of a length of tubing to be held by said tubing holder;
a connector piece attached to said first band and to said second band, for holding said bands in a spaced apart relationship; wherein
said bands allow said tubing to be inserted through said first and second gaps, with said bands holding said tubing in a position based on the relative orientation of said bands.

2. The tubing holder of claim 1 in which said bands are set at different angles from one another, to hold said tubing in a curve set by the relative orientation of said bands.

3. The tubing holder of claim 1 in which said connector piece is curved to match the radial surface curvature of said tubing.

4. A tubing holder for holding tubing at a selected angle, comprising:
a device body which defines a curved shape, with a side inside said curve, a side outside said curve, a left side, and a right side;
said device body having a first band configured to partially encircle a generally round cross section tubing, said first band with a first gap on said left or right side of said device body, for passage of a length of tubing to be held by said tubing holder;
said device body having a second band configured to partially encircle a generally round cross section tubing, said second band with a second first gap on said left or right side of said device body, for passage of a length of tubing to be held by said tubing holder;
said device body having a curved connector piece attached to said first band and to said second band, for holding said bands in a spaced apart relationship and defining a curve of the tubing being bent; wherein
said bands allow said tubing to be inserted sideways through said first and second gaps, with said bands holding said tubing in a position based on the relative orientation of said bands.

5. The tubing holder of claim 4 in which said connector piece is curved to match a curving sidewall of said tubing being held.
